(19) United States
(12) Patent Application Publication
(10) Pub. No.: US 2023/0413385 A1
(43) Pub. Date: Dec. 21, 2023

(54) HEATING DEVICE AND CONTROL METHOD THEREOF

(71) Applicants: QINGDAO HAIER SPECIAL REFRIGERATOR CO., LTD., Qingdao City, Shandong Province (CN); QINGDAO HAIER REFRIGERATOR CO., LTD., Qingdao City, Shandong Province (CN); HAIER SMART HOME CO., LTD., Qingdao City, Shandong Province (CN)

(72) Inventors: ZHIQIANG HAN, Qingdao City, Shandong Province (CN); XIAOBING ZHU, Qingdao City, Shandong Province (CN); CHUNYANG LI, Qingdao City, Shandong Province (CN); MING WANG, Qingdao City, Shandong Province (CN)

(21) Appl. No.: 18/038,018

(22) PCT Filed: Oct. 15, 2021
(86) PCT No.: PCT/CN2021/124128

§ 371 Date: May 20, 2023

(30) Foreign Application Priority Data
Nov. 20, 2020 (CN) 202011314469.4

(51) Int. Cl. H05B 1/02; H05B 6/62; F25D 21/00

(52) U.S. Cl. CPC H05B 1/0261; H05B 6/62; F25D 21/006

(57) ABSTRACT

The present invention provides a heating device and a control method thereof. The heating device includes an electromagnetic wave generating module and a matching module. The control method includes: controlling an electromagnetic wave generating module to generate an electromagnetic wave signal of a preset heating power; and determining a load matching degree of the electromagnetic wave generating module, and adjusting impedance of the matching module based on the load matching degree. When the load matching degrees determined within a preset adjustment time are all less than or equal to a first matching threshold, the electromagnetic wave generating module is controlled to stop working, such that the object to be processed that contains more components having a poor electromagnetic wave absorption capacity is prevented from being continuously heated after its moisture has been converted from ice to liquid.

### TECHNICAL FIELD

The present invention relates to the field of food processing, and in particular to a control method for an electromagnetic wave heating device and a heating device.

### BACKGROUND ART

The quality of food is guaranteed during the process of food freezing. However, frozen food needs to be thawed before processing or eating. For ease of thawing the food, a user usually adopts an electromagnetic wave heating device to thaw the food.

Thawing the food by the electromagnetic wave heating device is not only fast and efficient, but also causes low loss of nutrients in food. However, different kinds of food have different capacities of absorbing electromagnetic waves due to their different compositions. In addition, the materials of containers holding the food may also make the food and the whole containers differ in their capacities of absorbing electromagnetic waves. As a result, an electromagnetic wave generating module is unable to accurately and appropriately stop working punctually, causing the food to be overheated or wasting system energy. In consideration of the overall design, it is necessary to provide a control method for an electromagnetic wave heating device and a heating device, which can make thawing end more accurately and appropriately.

### SUMMARY OF THE INVENTION

In a first aspect, an objective of the present invention is to overcome at least one technical defect in the prior art by providing a control method for an electromagnetic wave heating device.

In the first aspect, another objective of the present invention is to save energy.

In the first aspect, yet another objective of the present invention is to prolong the service life of an electromagnetic wave generating module.

In a second aspect, an objective of the present invention is to provide an electromagnetic wave heating device.

According to the first aspect of the present invention, a control method for a heating device is provided. The heating device includes an electromagnetic wave generating module configured to generate an electromagnetic wave signal for heating an object to be processed, and a matching module configured to adjust load impedance of the electromagnetic wave generating module by adjusting its own impedance. The control method includes:
controlling the electromagnetic wave generating module to generate an electromagnetic wave signal of a preset heating power; and
determining a load matching degree of the electromagnetic wave generating module and adjusting impedance of the matching module based on the load matching degree; wherein the control method further includes:
controlling, if the load matching degrees determined within a preset adjustment time are all less than or equal to a first matching threshold, the electromagnetic wave generating module to stop working.

Optionally, the control method further includes:
determining the preset adjustment time based on a weight of the object to be processed.

Optionally, the step of determining the preset adjustment time based on the weight of the object to be processed includes:
matching the preset adjustment time based on the weight according to a preset weight-time corresponding relationship; wherein
the weight-time corresponding relationship records preset adjustment times corresponding to different weights, and the preset adjustment time is in positive correlation with the weight.

Optionally, the control method further includes:
controlling, if the load matching degree is less than or equal to a second matching threshold, the electromagnetic wave generating module to stop working; wherein
the second matching threshold is smaller than the first matching threshold.

Optionally, the control method further includes:
determining a change rate of a dielectric coefficient of the object to be processed; and
controlling, if the change rate is reduced to be less than or equal to a change rate threshold, the electromagnetic wave generating module to stop working.

Optionally, the control method further includes:
determining the change rate threshold based on the weight of the object to be processed.

Optionally, the step of determining the change rate threshold based on the weight of the object to be processed includes:
matching the change rate threshold based on the weight according to a preset weight-rate corresponding relationship; wherein
the weight-rate corresponding relationship records change rate thresholds corresponding to different weights, and the change rate threshold is in negative correlation with the weight.

Optionally, before controlling the electromagnetic wave generating module to generate the electromagnetic wave signal of the preset heating power, the control method further includes:
controlling the electromagnetic wave generating module to generate an electromagnetic wave signal of a preset initial power;
adjusting impedance of the matching module, and determining an impedance value of the matching module that maximizes the load matching degree of the electromagnetic wave generating module; and
determining the weight based on the impedance value; wherein
in the step of determining the weight based on the impedance value, determining the weight based on a maximum impedance value if a plurality of impedance values of the matching module maximize the load matching degree of the electromagnetic wave generating module.

Optionally, the control method further includes:
executing, at every preset time interval, the step of determining the load matching degree of the electromagnetic wave generating module; and/or
executing, if the load matching degree is less than or equal to the first matching threshold, the step of adjusting the impedance of the matching module based on the load matching degree.

According to the second aspect of the present invention, a heating device is provided. The heating device includes:
a cavity capacitor configured to receive an object to be processed;
an electromagnetic wave generating module configured to generate an electromagnetic wave signal for heating the object to be processed within the cavity capacitor;
a matching module configured to adjust load impedance of the electromagnetic wave generating module by adjusting its own impedance; and
a controller configured to execute the control method described above.

According to the present invention, by determining the load matching degree after adjustment of the impedance, if the load matching degrees continuously determined within the preset adjustment time are all less than or equal to a preset first matching degree, the electromagnetic wave generating module is caused to stop working, such that the object to be processed that contains more components having a poor electromagnetic wave absorption capacity may be prevented from being continuously heated after its moisture has been converted from ice to liquid, which further prevents the object to be processed from being overheated, guarantees the quality of the object to be processed, reduces undesired waste of energy, and hence prolongs the service life of the electromagnetic wave generating module.

Further, according to the present invention, whether the heating of the object to be processed is completed is determined based on the change rate of the dielectric coefficient of the object to be processed rather than temperature and time, so that the object to be processed is more accurately in in a state expected by a user. For example, the heated food may be at −4° C. to 2° C. by setting the change rate threshold. Thus, it is easy to cut and process the object to be processed, and the object to be processed, e.g., meat, is prevented from producing bloody water.

Further, according to the present invention, the electromagnetic wave generating module stops working when the load matching degree is less than or equal to the second matching threshold, so as to avoid an extremely low load matching degree caused by the object to be processed that is overweight and oversized or underweight and undersized, and prevent more electromagnetic waves from being reflected back to the electromagnetic wave generating module to burn the electromagnetic wave generating module and to even cause potential safety hazards.

The aforesaid and other objectives, advantages and features of the present invention will be more apparent to those skilled in the art from the following detailed description of the specific embodiments of the present invention with reference to the accompanying drawings.

### BRIEF DESCRIPTION OF THE DRAWINGS

The following will describe some specific embodiments of the present invention in detail in an exemplary rather than restrictive manner with reference to the accompanying drawings. The same reference signs in the drawings represent the same or similar components or parts. Those skilled in the art shall understand that these drawings may not be necessarily drawn to scale. In the drawings:

FIG. 1 is a schematic structural diagram of a heating device according to an embodiment of the present invention;

FIG. 2 is a schematic structural diagram of a controller in FIG. 1;

FIG. 3 is a schematic circuit diagram of a matching module according to an embodiment of the present invention;

FIG. 4 is a schematic flowchart of a control method for a heating device according to an embodiment of the present invention; and

FIG. 5 is a detailed flowchart of a control method for a heating device according to an embodiment of the present invention.

### DETAILED DESCRIPTION

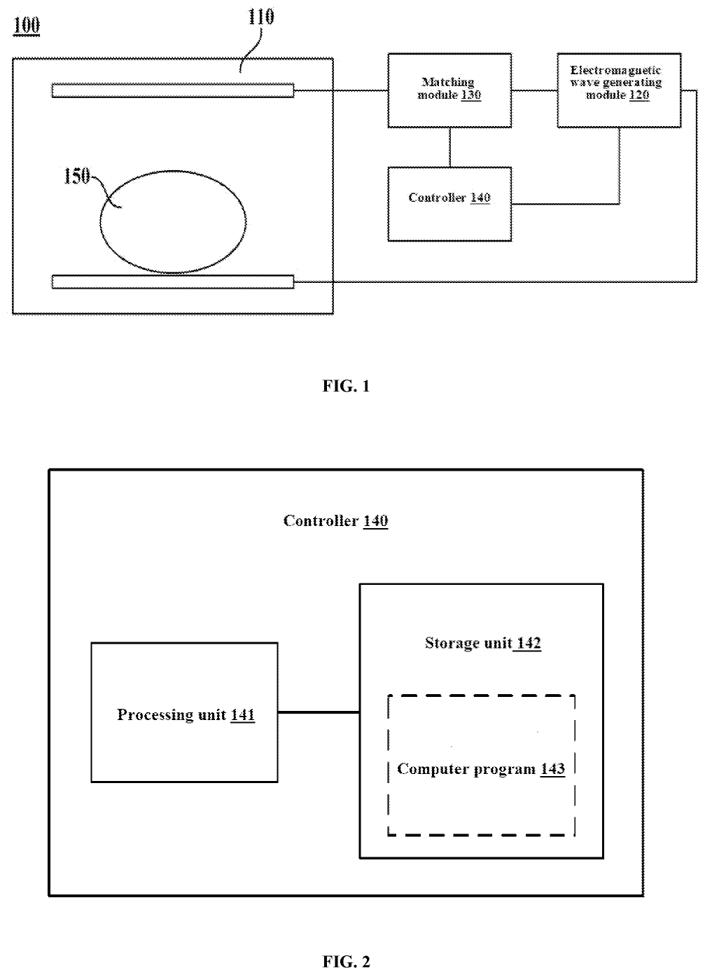

FIG. 1 is a schematic structural diagram of a heating device 100 according to an embodiment of the present invention. Referring to FIG. 1, the heating device 100 may include a cavity capacitor 110, an electromagnetic wave generating module 120, a matching module 130, and a controller 140.

Specifically, the cavity capacitor 110 may include a cavity for receiving an object to be processed 150 and a radiating polar plate arranged in the cavity. In some embodiments, a receiving polar plate may also be arranged in the cavity to form a capacitor with the radiating polar plate. In other embodiments, the cavity may be made of metal so as to be used as the receiving polar plate to form a capacitor with the radiating polar plate.

The electromagnetic wave generating module 120 may be configured to generate an electromagnetic wave signal and may be electrically connected to the radiating polar plate of the cavity capacitor 110 to generate electromagnetic waves in the cavity capacitor 110 and to further heat the object to be processed 150 in the cavity capacitor 110.

The matching module 130 may be connected in series between the electromagnetic wave generating module 120 and the cavity capacitor 110 or in parallel at two ends of the cavity capacitor 110 and configured to adjust load impedance of the electromagnetic wave generating module 120 by adjusting its own impedance so as to achieve load matching and improve the heating efficiency.

FIG. 2 is a schematic structural diagram of the controller 140 in FIG. 1. Referring to FIG. 2, the controller 140 may include a processing unit 141 and a storage unit 142. The storage unit 142 stores a computer program 143, and the computer program 143 is configured to, when executed by the processing unit 141, implement the control method according to the embodiment of the present invention.

The processing unit 141 may be configured to determine a load matching degree of the electromagnetic wave generating module 120 after the electromagnetic wave generating module 120 is controlled to generate an electromagnetic wave signal of a preset heating power, and may also be configured to adjust impedance of the matching module 130 based on the load matching degree, so as to increase the absorption rate of the electromagnetic waves by the object to be processed 150 and improve the heating efficiency. The higher load matching degree indicates a higher proportion of output power allocated by the electromagnetic wave generating module 120 to the cavity capacitor 110 and higher heating efficiency of the object to be processed 150 under the same other conditions.

The heating device 100 may further include a bidirectional coupler connected in series between the cavity capacitor 110 and the electromagnetic wave generating module 120 for real-time monitoring of a forward power signal output by the electromagnetic wave generating module 120 and a reverse power signal returned to the electromagnetic wave generating module 120. The load matching degree may be a difference between the number 1 and a ratio of the reverse power signal to the forward power signal.

In particular, upon determination of the load matching degree of the electromagnetic wave generating module 120, the processing unit 141 may be configured to: when the load matching degrees determined within a preset adjustment time are all less than or equal to a first matching threshold, control the electromagnetic wave generating module 120 to stop working, such that the object to be processed 150 that contains more components with a poor electromagnetic wave absorption capacity may be prevented from being continuously heated after its moisture has been converted from ice to liquid, which further prevents the object to be processed 150 from being overheated, guarantees the quality of the object to be processed 150, reduces undesired waste of energy, and hence prolongs the service life of the electromagnetic wave generating module 120.

The processing unit 141 may be configured to determine, at every preset time interval, the load matching degree of the electromagnetic wave generating module 120. That is, when the load matching degrees determined for consecutive preset times are all less than or equal to the first matching threshold, the electromagnetic wave generating module 120 is controlled to stop working.

The processing unit 141 may be configured to adjust impedance of the matching module 130 based on the load matching degree when the load matching degree is less than or equal to the first matching threshold, so as to ensure the absorption rate of the electromagnetic waves by the object to be processed 150.

Alternatively, the load matching degree may be indicated by return loss, and a lower return loss indicates a higher proportion of output power allocated by the electromagnetic wave generating module 120 to the cavity capacitor 110 and higher heating efficiency of the object to be processed 150 under the same other conditions.

Upon determination of the return loss of the electromagnetic wave generating module 120, the processing unit 141 may be configured to, when the return losses determined within the preset adjustment time are all greater than a preset loss threshold, control the electromagnetic wave generating module 120 to stop working.

In some embodiments, the processing unit 141 may be configured to determine the preset adjustment time based on the weight of the object to be processed 150, so as to improve the accuracy of determining whether heating of the object to be processed 150 has been substantially completed and whether there is a component with the poor electromagnetic wave absorption capacity.

The processing unit 141 may match the preset adjustment time based on the weight according to a preset weight-time corresponding relationship in the storage unit 142. The weight-time corresponding relationship records the preset adjustment times corresponding to different weights, and the preset adjustment time is in positive correlation with the weight, so as to adapt to different objects to be processed 150 and make the electromagnetic wave generating module 120 stop more accurately.

For example, the weight-time corresponding relationship records the preset adjustment times corresponding to different weight ranges. The larger an intermediate value of the weight range is, the longer the corresponding preset adjustment time is.

In some embodiments, during the process of heating, the processing unit 141 may be configured to determine a change rate of a dielectric coefficient of the object to be processed 150, and control, when the change rate is reduced to be less than or equal to a change rate threshold, the electromagnetic wave generating module 120 to stop working, thereby causing, together with threshold judgment of the load matching degree, the object to be processed 150 to stop more accurately in a state expected by the user.

The processing unit 141 may determine the change rate threshold based on the weight of the object to be processed 150, so as to improve the accuracy of determining whether the heating is completed.

The processing unit 141 may match the change rate threshold based on the weight according to a preset weight-rate corresponding relationship. The weight-rate corresponding relationship records the change rate thresholds corresponding to different weights, and the change rate threshold is in negative correlation with the weight, so as to adapt to the demand of the objects to be processed 150 with different weights for electromagnetic wave energy, and make the electromagnetic wave generating module 120 stop more accurately.

In some further embodiments, the weight of the object to be processed 150 may be determined by an initial impedance value of the matching module 130 that achieves the best load matching of the electromagnetic wave generating module 120, so as to improve the accuracy of the weight and reduce the production cost.

Specifically, before controlling the electromagnetic wave generating module 120 to generate the electromagnetic wave signal of the preset heating power, the processing unit 141 may be configured to control the electromagnetic wave generating module 120 to generate an electromagnetic wave signal of a preset initial power, adjust impedance of the matching module 130, determine an impedance value of the matching module 130 that maximizes the load matching degree of the electromagnetic wave generating module 120, and then determine the weight based on the impedance value. The weight is determined based on the maximum impedance value if multiple impedance values of the matching module 130 maximize the load matching degree of the electromagnetic wave generating module 120.

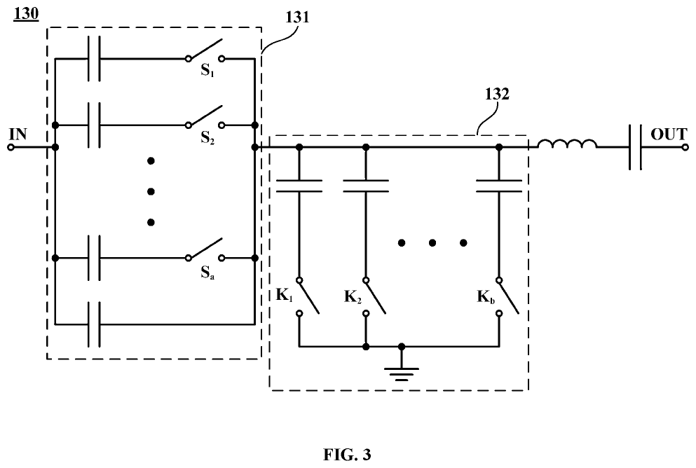

FIG. 3 is a schematic circuit diagram of a matching module 130 according to an embodiment of the present invention. Referring to FIG. 3, in some embodiments, the matching module 130 may include a first matching unit 131 connected in series between the electromagnetic wave generating module 120 and the cavity capacitor 110, and a second matching unit 132 of which one end is electrically connected between the first matching unit 131 and the cavity capacitor 110 and the other end is grounded.

Each of the first matching unit 131 and the second matching unit 132 may include a plurality of matching branches connected in parallel, and each matching branch includes one fixed capacitor and one switch, such that the matching module 130 is improved in reliability and widened in range of adjustment while the circuit is made simple.

The first matching unit 131 may be mainly configured to adjust the frequency of resonance points, and the fixed capacitors of the multiple matching branches of the first matching unit 131 have different capacitance values and are controlled by switches S₁, S₂ . . . and Sₐ respectively. The second matching unit 132 may be mainly configured to further adjust the frequency and the amplitude of the resonance points, and the fixed capacitors of the multiple matching branches of the second matching unit 132 have different capacitance values and are controlled by switches K₁, K₂ . . . and K_{b} respectively.

In some further embodiments, the processing unit 141 may be configured to adjust on-off states of the switches K₁, K₂ . . . and K_{b} in the second matching unit 132 in a dichotomy manner, gradually narrow a capacitance value range that achieves the maximum load matching degree, determine the capacitance value of the second matching unit 132 that achieves the maximum load matching degree (the capacitance value of the second matching unit 132 may be directly represented by a switch number of the capacitance value of the second matching unit 132) and further determine the weight of the object to be processed.

Exemplarily, the second matching unit 132 is provided with 15 switches (i.e., b=15) in total which are sequentially switches K₁, K₂ . . . K₁₄ and K₁₅. The processing unit 141 may first turn on the switches K₈, K₁₂ and K₄ of the second matching unit 132, and determine the load matching degree by respectively traversing the switches S₁, S₂ . . . and Sₐ of the corresponding first matching unit 131. If the switch K₁₂ corresponds to the maximum load matching degree, it may be determined that an optimal value lies between the switches K₈ and K₁₅. The switches K₁₀ and K₁₄ of the second matching unit 132 are turned on, the load matching degree is determined by respectively traversing the switches S₁, S₂ . . . Sₐ of the corresponding first matching unit 131, and in a similar fashion, the switch number of the second matching unit 132 that achieves the maximum load matching degree is determined.

In some other embodiments, the processing unit 141 may be configured to divide the capacitance value range of the second matching unit 132 into a plurality of sub-ranges, determine an intermediate value with the maximum load matching degree among intermediate values of the plurality of sub-ranges, and then determine, by traversing all the capacitance values of this sub-range, the capacitance value of the second matching unit 132 that achieves the maximum load matching degree, so as to determine the weight of the object to be processed 150.

Exemplarily, the second matching unit 132 is provided with 15 switches (i.e., b=15) in total which are sequentially switches K₁, K₂ . . . K₁₄ and K₁₅. The processing unit 141 may first turn on the switches K₂, K₄, K₆, K₈, K₁₀, K₁₂ and K₁₄ of the second matching unit 132, and determine the load matching degree by traversing the switches S₁, S₂ . . . Sₐ of the corresponding first matching unit 131. If the switch K₁₂ corresponds to the maximum load matching degree, it may be determined that an optimal value lies between the switches K₁₁ and K₁₃. The switches K₁₅ and K₁₃ of the second matching unit 132 are turned on, and the load matching degree is determined by traversing the switches S₁, S₂ . . . , Sₐ of the corresponding first matching unit 131, so as to determine the switch number of the second matching unit 132 that achieves the maximum load matching degree.

In some other embodiments, the weight of the object to be processed 150 may also be detected and acquired by a weight sensor, or manually input by the user.

In some embodiments, the processing unit 141 may be configured to: when the load matching degree is smaller than a second matching threshold, control the electromagnetic wave generating module 120 to stop working. The second matching threshold may be smaller than the first matching threshold, so as to avoid an extremely low load matching degree caused by the object to be processed 150 that is overweight and oversized or underweight and undersized, and prevent more electromagnetic waves from being reflected back to the electromagnetic wave generating module 120 to burn the electromagnetic wave generating module 120 and to even cause potential safety hazards.

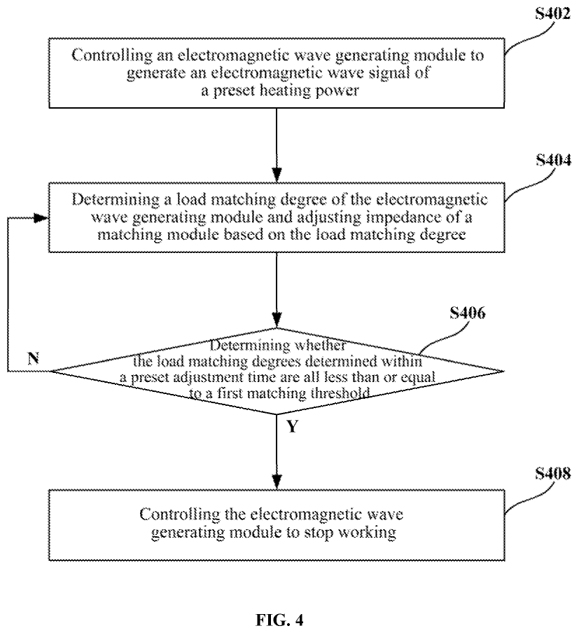

FIG. 4 is a schematic flowchart of a control method for a heating device 100 according to an embodiment of the present invention (in the accompanying drawings of the Description of the present invention, “Y” denotes “Yes” and “N” denotes “No”). Referring to FIG. 4, the control method for the heating device 100 according to the present invention may include the following steps:
step S402: controlling an electromagnetic wave generating module 120 to generate an electromagnetic wave signal of a preset heating power;
step S404: determining a load matching degree of the electromagnetic wave generating module 120 and adjusting impedance of a matching module 130 based on the load matching degree;
step S406: determining whether the load matching degrees determined within a preset adjustment time are all less than or equal to a first matching threshold; if yes, executing S408; and if no, returning to S404; and
step S408: controlling the electromagnetic wave generating module 120 to stop working.

In the control method according to the present invention, by determining the load matching degree after adjustment of the impedance, if the load matching degrees continuously determined within the preset adjustment time are all less than or equal to a preset first matching degree, the electromagnetic wave generating module 120 is caused to stop working, such that the object to be processed 150 that contains more components with the poor electromagnetic wave absorption capacity may be prevented from being continuously heated after its moisture has been converted from ice to liquid, which further prevents the object to be processed 150 from being overheated, guarantees the quality of the object to be processed 150, reduces undesired waste of energy, and hence prolongs the service life of the electromagnetic wave generating module 120.

The load matching degree of the electromagnetic wave generating module 120 may be determined at every preset time interval. That is, when the load matching degrees determined for consecutive preset times are all less than or equal to the first matching threshold, the electromagnetic wave generating module 120 is controlled to stop working.

The impedance of the matching module 130 may be adjusted based on the load matching degree when the load matching degree is less than or equal to the first matching threshold, so as to ensure the absorption rate of the electromagnetic waves by the object to be processed 150.

In some embodiments, the preset adjustment time may be determined based on the weight of the object to be processed 150, so as to improve the accuracy of determining whether heating of the object to be processed 150 has been substantially completed and whether there is a component with the poor electromagnetic wave absorption capacity.

The preset adjustment time may be acquired by matching based on the weight according to a preset weight-time corresponding relationship in the storage unit 142. The weight-time corresponding relationship records the preset adjustment times corresponding to different weights, and the preset adjustment time is in positive correlation with the weight, so as to adapt to different objects to be processed 150 and make the electromagnetic wave generating module 120 stop more accurately.

In some embodiments, the control method may further include: determining a change rate of a dielectric coefficient of the object to be processed 150; and controlling, if the change rate is reduced to be less than or equal to a change rate threshold, the electromagnetic wave generating module 120 to stop working, to cause, together with threshold judgment of the load matching degree, the object to be processed 150 to stop more accurately in a state expected by the user.

The change rate threshold may be determined based on the weight of the object to be processed 150, so as to improve the accuracy of determining whether the heating is completed.

The change rate threshold may be acquired by matching based on the weight according to a preset weight-rate corresponding relationship. The weight-rate corresponding relationship records the change rate thresholds corresponding to different weights, and the change rate threshold is in negative correlation with the weight, so as to adapt to the demand of the objects to be processed 150 with different weights for electromagnetic wave energy, and make the electromagnetic wave generating module 120 stop more accurately.

In some other embodiments, the weight of the object to be processed 150 may be determined by an initial impedance value of the matching module 130 that achieves the best load matching of the electromagnetic wave generating module 120, so as to improve the accuracy of the weight and reduce the production cost. Specifically, the weight of the object to be processed 150 may be acquired by the following steps:
controlling the electromagnetic wave generating module 120 to generate an electromagnetic wave signal of a preset initial power, wherein the preset initial power may be less than preset heating power, so as to reduce the influence on a heating effect of the object to be processed 150 in a weight acquisition stage and reduce damage to the electromagnetic wave generating module 120;
adjusting impedance of the matching module 130 and determining an impedance value of the matching module 130 that maximizes the load matching degree of the electromagnetic wave generating module 120; and
determining the weight based on the impedance value this step, the weight is determined based on a maximum impedance value if a plurality of impedance values of the matching module 130 maximize the load matching degree of the electromagnetic wave generating module 120).

In some embodiments, the control method may further include: controlling, if the load matching degree is smaller than the second matching threshold, the electromagnetic wave generating module 120 to stop working. The second matching threshold is less than the first matching threshold, so as to avoid an extremely low load matching degree caused by the object to be processed 150 that is overweight and oversized or underweight and undersized, and prevent more electromagnetic waves from being reflected back to the electromagnetic wave generating module 120 to burn the electromagnetic wave generating module 120 and to even cause potential safety hazards.

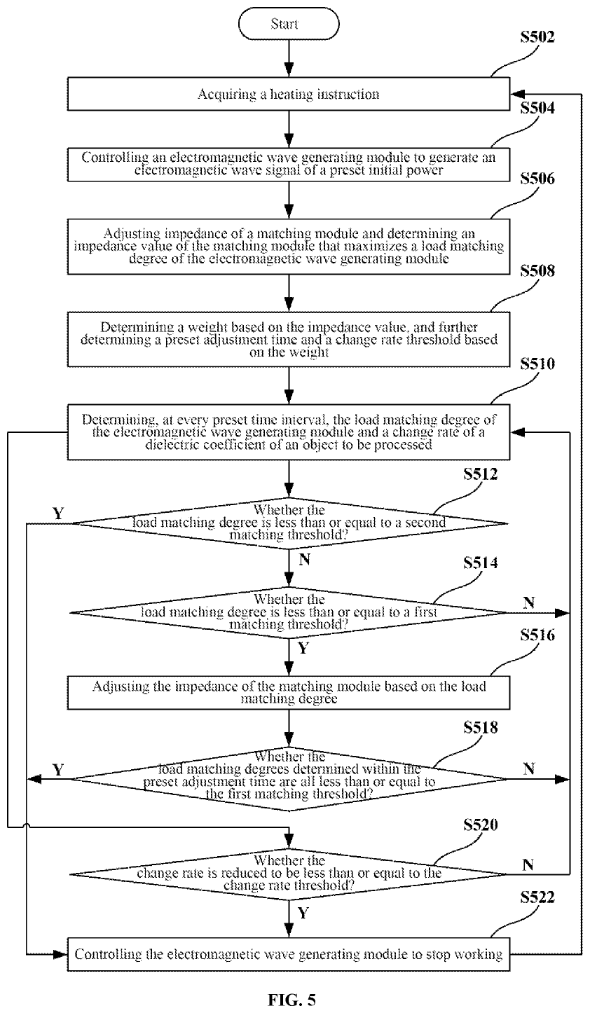

FIG. 5 is a detailed flowchart of a control method for a heating device 100 according to an embodiment of the present invention. Referring to FIG. 5, the control method for the heating device 100 according to the present invention may include the following steps in detail:
step S502: acquiring a heating instruction;
step S504: controlling an electromagnetic wave generating module 120 to generate an electromagnetic wave signal of a preset initial power;
step S506: adjusting impedance of the matching module 130 and determining an impedance value of the matching module 130 that maximizes a load matching degree of the electromagnetic wave generating module 120;
step S508: determining a weight based on the impedance value of the matching module 130 that maximizes the load matching degree of the electromagnetic wave generating module 120, and further determining a preset adjustment time and a change rate threshold based on the weight;
step S510: determining, at every preset time interval, the load matching degree of the electromagnetic wave generating module 120 and a change rate of a dielectric coefficient of the object to be processed 150, and executing S512 and S520,
step S512: determining whether the load matching degree is less than or equal to a second matching threshold; if yes, executing S522; and if no, executing S514;
step S514: determining whether the load matching degree is less than or equal to a first matching threshold; if yes, executing S516 and S518; and if no, returning to S510;
step S516: adjusting the impedance of the matching module 130 based on the load matching degree;
step S518: determining whether the load matching degrees determined within the preset adjustment time are all less than or equal to the first matching threshold; if yes, executing S522; and if no, returning to S510;
step S520: determining whether the change rate of the dielectric coefficient of the object to be processed 150 is reduced to be less than or equal to a change rate threshold; if yes, executing S522; and if no, returning to S510; and

S522: controlling the electromagnetic wave generating module 120 to stop working, and returning to S502.

Therefore, it should be recognized by those skilled in the art that although multiple exemplary embodiments of the present invention have been illustrated and described in detail, many other variations or modifications that accord with the principle of the present invention may be still determined or derived directly from the content disclosed by the present invention without departing from the spirit and scope of the present invention. Thus, the scope of the present invention should be understood and deemed to include all these variations or modifications.

1. A control method for a heating device, wherein the heating device comprises an electromagnetic wave generating module configured to generate an electromagnetic wave signal for heating an object to be processed, and a matching module configured to adjust load impedance of the electromagnetic wave generating module by adjusting its own impedance, wherein the control method comprises:
controlling the electromagnetic wave generating module to generate an electromagnetic wave signal of a preset heating power; and
determining a load matching degree of the electromagnetic wave generating module and adjusting impedance of the matching module based on the load matching degree; wherein the control method further comprises:
controlling, if the load matching degrees determined within a preset adjustment time are all less than or equal to a first matching threshold, the electromagnetic wave generating module to stop working.

2. The control method according to claim 1, further comprising:
determining the preset adjustment time based on a weight of the object to be processed.

3. The control method according to claim 2, wherein the step of determining the preset adjustment time based on the weight of the object to be processed comprises:
matching the preset adjustment time based on the weight according to a preset weight-time corresponding relationship; wherein
the weight-time corresponding relationship records preset adjustment times corresponding to different weights, and the preset adjustment time is in positive correlation with the weight.

4. The control method according to claim 1, further comprising:
controlling, if the load matching degree is less than or equal to a second matching threshold, the electromagnetic wave generating module to stop working; wherein
the second matching threshold is smaller than the first matching threshold.

5. The control method according to claim 1, further comprising:
determining a change rate of a dielectric coefficient of the object to be processed; and
controlling, if the change rate is reduced to be less than or equal to a change rate threshold, the electromagnetic wave generating module to stop working.

6. The control method according to claim 5, further comprising:
determining the change rate threshold based on the weight of the object to be processed.

7. The control method according to claim 6, wherein the step of determining the change rate threshold based on the weight of the object to be processed comprises:
matching the change rate threshold based on the weight according to a preset weight-rate corresponding relationship; wherein
the weight-rate corresponding relationship records change rate thresholds corresponding to different weights, and the change rate threshold is in negative correlation with the weight.

8. The control method according to claim 6, wherein before controlling the electromagnetic wave generating module to generate the electromagnetic wave signal of the preset heating power, the control method further comprises:
controlling the electromagnetic wave generating module to generate an electromagnetic wave signal of a preset initial power;
adjusting the impedance of the matching module, and determining an impedance value of the matching module that maximizes the load matching degree of the electromagnetic wave generating module; and
determining the weight based on the impedance value; wherein
in the step of determining the weight based on the impedance value, determining the weight based on a maximum impedance value if a plurality of impedance values of the matching module maximize the load matching degree of the electromagnetic wave generating module.

9. The control method according to claim 1, further comprising:
executing, at every preset time interval, the step of determining the load matching degree of the electromagnetic wave generating module; and/or
executing, if the load matching degree is less than or equal to the first matching threshold, the step of adjusting the impedance of the matching module based on the load matching degree.

10. A heating device, comprising:
a cavity capacitor configured to receive an object to be processed;
an electromagnetic wave generating module configured to generate an electromagnetic wave signal for heating the object to be processed within the cavity capacitor;
a matching module configured to adjust load impedance of the electromagnetic wave generating module by adjusting its own impedance; and
a controller configured to execute the control method as defined in claim 1.

11. The control method according to claim 2, wherein before controlling the electromagnetic wave generating module to generate the electromagnetic wave signal of the preset heating power, the control method further comprises:
controlling the electromagnetic wave generating module to generate an electromagnetic wave signal of a preset initial power;
adjusting the impedance of the matching module, and determining an impedance value of the matching module that maximizes the load matching degree of the electromagnetic wave generating module; and
determining the weight based on the impedance value; wherein
in the step of determining the weight based on the impedance value, determining the weight based on a maximum impedance value if a plurality of impedance values of the matching module maximize the load matching degree of the electromagnetic wave generating module.
